(19) United States
(12) Patent Application Publication
(10) Pub. No.: US 2004/0128668 A1
(43) Pub. Date: Jul. 1, 2004

(54) Application package device, method and program for customizing application package

(75) Inventor: Hitoshi Iuchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/732,216

(22) Filed: Dec. 11, 2003

(30) Foreign Application Priority Data
Dec. 25, 2002 (JP) 375337/2002

(51) Int. Cl. G06F 9/445

(52) U.S. Cl. 717/174; 717/121; 717/164

(57) ABSTRACT

An application package device with which a user can perform test customization without causing other users inconvenience before actual customization. First, a customization defining section stores customization information in either an individual customization information database or a shared customization information database. At the time of customization, a customization performing section searches the individual customization information database for customization information under the keywords of a user name and an object name such as an image name and a form name. When succeeding in the searching, the customization performing section performs the customization processes on the basis of the retrieved customization information. On the other hand, when failing in the searching, the customization performing section searches the shared customization information database for the customization information under the keyword of the object name. When succeeding in the searching, the customization performing section performs the customization processes on the basis of the retrieved customization information. On the other hand, when failing in the searching, the customization performing section performs processes defined as a default.

### BACKGROUND OF THE INVENTION

The present invention relates to an application package device provided with an application package such as an ERP Package (Enterprise Resource Planning Package) that is supposedly used among the unspecified number of users and that can be customized by a user (such as an administrator), a method and a program for customizing the application package.

### DESCRIPTION OF THE RELATED ART

Some application packages have customization features operated by a user. When performing a customization, a user changes display screens and operations in accordance with the user's purpose to the extent permitted by the customization features. Namely, a user performs customization by inputting the changes (customization information) into a device to store them in the device without changing a source code of the application package.

One of the conventional systems for customizing an application package is disclosed in Japanese Patent Application Laid-Open No. 2001-147801 by the same applicant.

In this system, there are included a rule storing section for storing operation rules of an application package, and a source converting section for converting input changes of an operation rule to a source code of the application package. Accordingly, the operation rule input by the user can be changed without rewriting the source code of the application package.

However, when a user makes a change (customization) in accordance with his/her purpose as above using the customization feature (customizing method) in the above-described application package, the customized result is applied to all of the other users.

Moreover, while the above-described disclosure is effective in that a user does not have to change a source code of an application package when changing operation rules, the changes (customization) which a user have performed is applied to all of the other users as with the above-described application package.

When a user (who has customization authorization) performs customization while the existing application package is carried on and used by a plurality of users (the unspecified number of users), the above-described problem leads to the following big problems.

First, when a user composes layouts of display screens, forms to be used, and the like by the use of an application package and tests them making a modification thereto while operating the application package, the modification (customization) is applied to all of the other users each time when the user introduces the modification. This may destabilize the layouts of the display screens and the forms, leading to deteriorated operationality and causing other users inconvenience.

Second, it is often the case that plural teams use an application package for, for example, production management and perform customization while practically operating the application package. In this case, when an upstream team performs customization in a test, the changes due to the customization are also applied to downstream teams. Accordingly, when the upstream team changes the display screens and operations in the test many times, the downstream teams accordingly has to operate the changed application package. This also destabilizes the operationality and causes the users inconvenience.

### SUMMARY OF THE INVENTION

It is therefore an object of the present invention to provide an application package device provided with an application package, in which, even when a user (who has customization authorization) customizes the application package while operating it, the user can performs test customization without causing other users inconvenience before performing actual customization, a method for customizing the application package and a program thereof (a program for the application package provided with a customization feature).

According to a first aspect of the present invention, for achieving the object mentioned above, there is provided an application package device provided with an application package, comprising:

an application package section for executing processes based on the application package;

an individual customization information storing section provided with respect to each user for storing customization information to customize the application package; and

a shared customization information storing section for storing customization information to customize the application package, wherein:

the application package section customizes the application package on the basis of the customization information stored in either the individual customization information storing section or the shared customization information storing section, and refers to the individual customization information storing section only when an associated user logs in.

According to a second aspect of the present invention, in the first aspect, the application package section:

searches the individual customization information storing section for customization information under the keywords of a name of a user who logs in and an object name when receiving a request for performing customization;

customizes the application package on the basis of the retrieved customization information when succeeding in searching the individual customization information storing section;

searches the shared customization information storing section for customization information under the keyword of the object name when failing in the searching the individual customization information storing section;

customizes the application package on the basis of the retrieved customization information when succeeding in searching the shared customization information storing section; and

executes processes defined in the application package as a default when failing in searching the shared customization information storing section.

According to a third aspect of the present invention, in the first or second aspect, the application package section comprises:

an application package control section for executing application processes defined in the application package;

a customization defining section for defining customization information in the application package; and

a customization performing section for performing customization in the application package on the basis of prestored customization information, wherein:

the application package control section invokes the customization defining section when receiving a request for defining customization, and invokes the customization performing section when receiving a request for performing customization.

According to a fourth aspect of the present invention, in any one of the first to third aspects:

the individual customization information storing section stores at least one customization information per one customization item that can be customized in the application package; and

the shared customization information storing section stores at most one customization information per one customization item.

According to a fifth aspect of the present invention, in any one of the first to fourth aspects, the application package section identifies the user name of the user who logs in to the application package section by information on a log of the application package.

According to a sixth aspect of the present invention, there is provided a method for customizing an application package in a computer provided with the application package, comprising:

an individual customization information storing step for storing customization information to customize the application package in an individual customization information storing means provided with respect to each user;

a shared customization information storing step for storing customization information to customize the application package in a shared customization information storing means; and

a customization performing step for customizing the application package on the basis of the customization information stored in either the individual customization information storing means or the shared customization information storing means, wherein:

the customization performing step is executed after executing at least one of the individual customization information storing step and the shared customization information storing step at least one time; and

the individual customization information storing means is referred to in the customization performing step only when an associated user logs in.

According to a seventh aspect of the present invention, in the sixth aspect, in the customization performing step, an application package means for executing processes based on the application package:

searches the individual customization information storing means for customization information under the keywords of a name of a user who logs in and an object name when receiving a request for performing customization;

customizes the application package on the basis of the retrieved customization information when succeeding in searching the individual customization information storing means;

searches the shared customization information storing means for customization information under the keyword of the object name when failing in searching the individual customization information storing means;

customizes the application package on the basis of the retrieved customization information when succeeding in searching the shared customization information storing means; and

executes processes defined as a default in the application package when failing in searching the shared customization information storing means.

According to an eighth aspect of the present invention, in the sixth or seventh aspect:

the individual customization information storing means stores at least one customization information per one customization item that can be customized in the application package; and

the shared customization information storing means stores at most one customization information per one customization item.

According to a ninth aspect of the present invention, in any one of the sixth to eighth aspects, the application package means identifies the user name of the user who logs in to the application package means by information on a log of the application package.

According to a tenth aspect of the present invention, there is provided a program for customizing an application package to have a computer provided with the application package execute:

an individual customization information storing process for storing customization information to customize the application package in an individual customization information storing means provided with respect to each user;

a shared customization information storing process for storing customization information to customize the application package in a shared customization information storing means; and

a customization performing process for customizing the application package on the basis of the customization information stored in either the individual customization information storing means or the shared customization information storing means, wherein:

the customization performing processes is executed after executing at least one of the individual customization information storing process and the shared customization information storing process at least one time; and

the individual customization information storing means is referred to in the customization performing process only when an associated user logs in.

According to an eleventh aspect of the present invention, in the tenth aspect, in the customization performing process, the program in the application package has the computer:

search the individual customization information storing means for customization information under the keywords of a name of a user who logs in and an object name when receiving a request for performing customization;

customize the application package on the basis of the retrieved customization information when succeeding in searching the individual customization information storing means;

search the shared customization information storing means for customization information under the keyword of the object name when failing in searching the individual customization information storing means;

customize the application package on the basis of the retrieved customization information when succeeding in searching the shared customization information storing means; and

execute processes defined as a default in the application package when failing in searching the shared customization information storing means.

According to a twelfth aspect of the present invention, in the tenth or eleventh aspect:

the individual customization information storing means stores at least one customization information per one customization item that can be customized in the application package; and

the shared customization information storing means stores at most one customization information per one customization item.

According to a thirteenth aspect of the present invention, in any one of the tenth to twelfth aspects, the program of the application package has the computer identify the user name of the user who logs in to the application package by information on a log of the application package.

Incidentally, the application processes in the above description means the processes to realize functions defined in the application package. For example, when employing an application package for production management, the processes to realize the production management are executed. For another example, when employing an application package for sales management, the processes to realize the sales management are executed.

Moreover, the keyword of the object's name in the above description means an object name such as an image name and a form name.

Furthermore, the phrase “when an associated user logs in” is used in the above description. This means a state where a user logs on the application package using information for identifying the user (for example, ID and password), and the user uses the application package.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a configuration of an application package device according to an embodiment of the present invention;

FIG. 2 is a diagram showing an example of a log-in screen, which is displayed on an output device 40 (display device) when a user is logging into the application package;

FIG. 3 is a diagram showing an example of an initial menu (menu screen) displayed on the output device 40 (display device) after the logging-in;

FIG. 4 is a flowchart showing an operation at the time of performing customization; and

FIG. 5 is a diagram showing an operative example of a storing state in a storing device 30.

### DESCRIPTION OF THE PREFERRED EMBODIMENT

Referring now to the drawings, an embodiment of an application package device, a method for customizing the application package, and a program thereof (program for the application package provided with the customization features) according to the present invention is explained in detail.

First, an application package device according to an embodiment of the present invention comprises an input device 10 such as a keyboard and a mouse, an application package section 20 that operates under a program control, a storing device 30 for storing information, and an output device 40 such as a display device and a printer.

The input device 10 receives inputs of instructions for customization, etc. from a user.

The output device 40 displays information thereon and/or prints out information, and the like according to settings (customized settings) in the application package section 20.

The application package section 20 executes processes based on the application package. The application package section 20 comprises an application package control section 21, a customization defining section 22, a customization performing section 23.

The application package section 20 is physically realized in the process of program of the application package, the program being executed by reserving a predetermined area in a memory of the application package device.

The application package control section 21 is invoked (activated) when the application package is activated. Subsequently, the application package control section 21 performs processes requested from the input device 10 to output the performed result to the output device 40. Namely, the application package control section 21 is activated at the same time just as the application package is activated to execute application processes defined in the application package.

This application processes are executed to realize the functions prescribed to the application package installed in the application package device of the present invention, namely, to fulfill the main functions of the application package device. For example, when the application package device of the present invention is provided with an application package for production management, application processes for realizing the production management are executed. For another example, when the application package device is provided with an application package for sales management, the application processes for realizing the sales management are executed.

The customization defining section 22 defines customization information in the application package. The customization defining section 22 is invoked by the application package control section 21 when receiving a request for defining customization from the input device 10. Subsequently, the section 22 stores customization information fed from the input device 10 in an individual customization information database 31 or a shared customization information database 32.

The customization performing section 23 customizes the application package on the basis of the customized information stored in the individual customization information database 31 and the shared customization information database 32.

When receiving the request to perform customization processes from the input device 10, the customization performing section 23 is invoked by the application package control section 21. Subsequently, the section 23 searches the individual customization information database 31 for customization information using a user name and an object name such as an image name, a form name, etc. as a key. When succeeding in the searching, the section 23 performs customization processes indicated by the retrieved customization information. On the other hand, when failing in the searching, the section 23 searches the shared customization information database 32 for customization information using the object name as a key. When succeeding in the searching, the section 23 performs customization processes indicated by the retrieved customization information. On the other hand, when failing in the searching, the section 23 performs processes prescribed to the application package as a default. The respective results of the performances are output to the output device 40.

Incidentally, while in the above description the customization performing section 23 is activated when receiving the request for performing customization from the input device 10, the start-up time is not limited thereto. Namely, the section 23 may be invoked by the application package control section 21 according to the settings in the application package control section 21. Moreover, the section 23 may be invoked when the user logs in.

The storing device 30 comprises the individual customization information database 31 (means for storing individual customization information) and the shared customization information database 32 (means for storing shared customization information).

The individual customization information database 31 stores customization information to customize the application package. The individual customization information database 31 is prepared with respect to each user. Namely, when the application package section 20 is logged in with a certain user name, the individual customization information database 31 dedicated to the user is referred to by the customization defining section 22 for storing customization information and by the customization performing section 23 for performing customization.

The individual customization information database 31 stores at least one piece of customization information per one customization item that can be customized in the application package.

By this means, one user can define at least one customization to test the usability of the customized application while the original application package is operated before determining the best customization.

The shared customization information database 32 stores customization information for customizing the application package. The shared customization information database 32 is provided for all of the users for common use. Namely, the shared customization information database 32 is referred to by the customization defining section 22 for storing customization information and by the customization performing section 23 for performing customization regardless of a logged-in user name.

The shared customization information database 32 stores only one piece of customization information per one customization item.

By this means, it becomes possible to easily determine the customization information defined in the shared customization information database 32 as the one to be shared by all of the users.

In the following, an explanation will be given of the outline of an operation of the application package device according to the embodiment of the present invention.

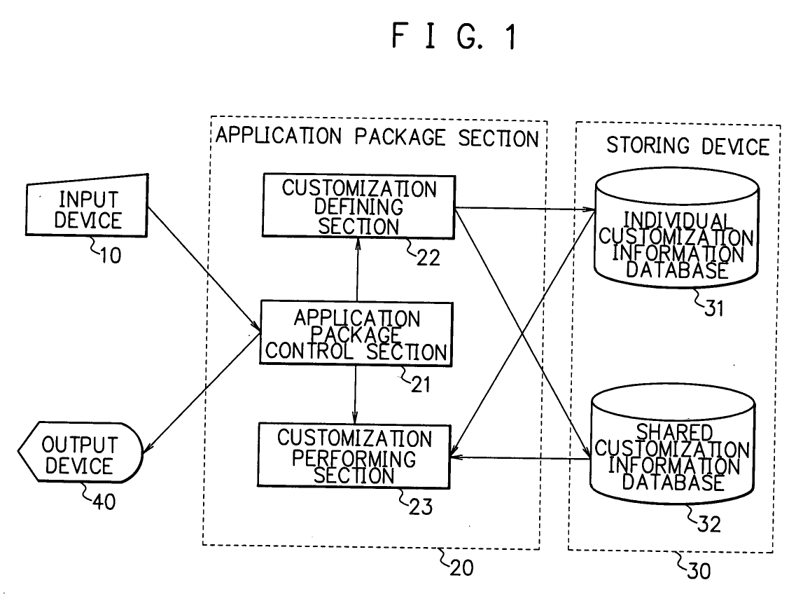

As shown in FIG. 1, the customization defining section 22 stores customization information in either the individual customization information database 31 or the shared customization information database 32.

When performing customization, the customization performing section 23 searches the individual customization information database 31 of a user for customization information under the keyword(s) such as a user name and an object name(s). Examples of the object name includes an image name, a form name, etc. When succeeding in the searching, the section 23 executes the customization processes indicated by the retrieved customization information. On the other hand, when failing in the searching, the section 23 searches the shared customization information database 32 for customization information under the keyword of the object name. When succeeding in the searching, the section 23 performs the customization processes indicated by the retrieved customization information. On the other hand, when failing in the searching, the section 23 performs processes defined in the application package as a default.

As described hereinbefore, the individual customization information database 31 and the shared customization information database 32 are separately managed. Further, the application package section 20 refers to the only individual customization information database 31 associated with a user who is logging in. By this means, a certain user (who has customization authorization) can perform test customization without causing other users inconvenience before performing actual customization (which is applied to all of the users).

In the following, an explanation will be given of an operation of the application package device according to the embodiment of the present invention in reference to FIGS. 1 to 4.

First, an explanation will be given of an operation when storing customization information for customizing the application package in the storing section 30. Incidentally, it is assumed in the following explanation that the output device 40 is a display device.

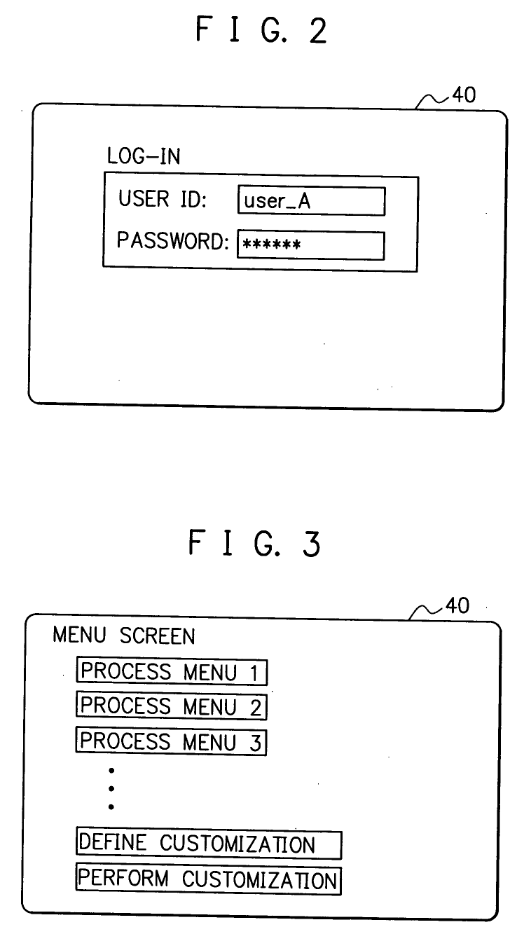

When a user logs in to the application package, the user inputs from the input device 10 a user ID (information for identifying the user) and a password using the screen as shown in FIG. 2, for example. When receiving the input log-in information (information such as a user ID and a password on a log of the application package), the application package section 20 identifies a user name to be used on the basis of the log-in information.

When the log-in procedures are normally performed, a menu screen (an initial image), for example, as shown in FIG. 3 is displayed on the output device 40. In order to define customization information, the user inputs a request for defining customization via the input device 10. When this request is input, the application package control section 21 invokes the customization defining section 22. The customization defining section 22 displays a predetermined customization screen on the output device 40. The user registers desired customization in accordance with the instructions on the screen.

The desired customization is registered in either the individual customization information database 31 or the shared customization information database 32. At the time of registration, the user may input to designate one of the two databases 31 and 32. Moreover, a “test mode” and “final mode” may be employed.

In the case where these two modes are employed, when the user defines customization information in the test mode, the customization information may be registered in the individual customization information database 31. On the other hand, when the user defines customization in the final mode, the customization information may be registered in the shared customization information database 32.

When the user registers the customization information adopting the two modes, first, the user defines customization information in the test mode. Subsequently, when the user determines that the defined customization information is suitable for actual operation, the user registers the customization information in the final mode. Hereat, when the user is uncertain whether or not the customization is suitable for actual operation, the user may define another customization information in the test mode to test the customization (customized application) for a while. Subsequently, when the user determines that the customization is suitable for the actual operation, the user registers the customization information in the final mode.

When the registration is performed in the test mode, the customization information is registered in the individual customization information database 31 of the user. When searching for the customization information, the customization performing section 23 refers to only the database 31 associated with the user who logs in. Accordingly, the user who registered the customization can test it without causing other users inconvenience. Moreover, the user can define (register) a plurality of customization information in the test mode to determine the best customization by testing the customized application package with several patterns, and can register the best one in the final mode.

As described above, the user stores customization information in the storing section 30 by registering the customization information at least one time (arbitrary times) in the individual customization information database 31 and/or the shared customization information database 32.

When the user executes a processing menu selected from the menu screen without storing any customization information, the application package control section 21 executes application processes defined in the application package as a default.

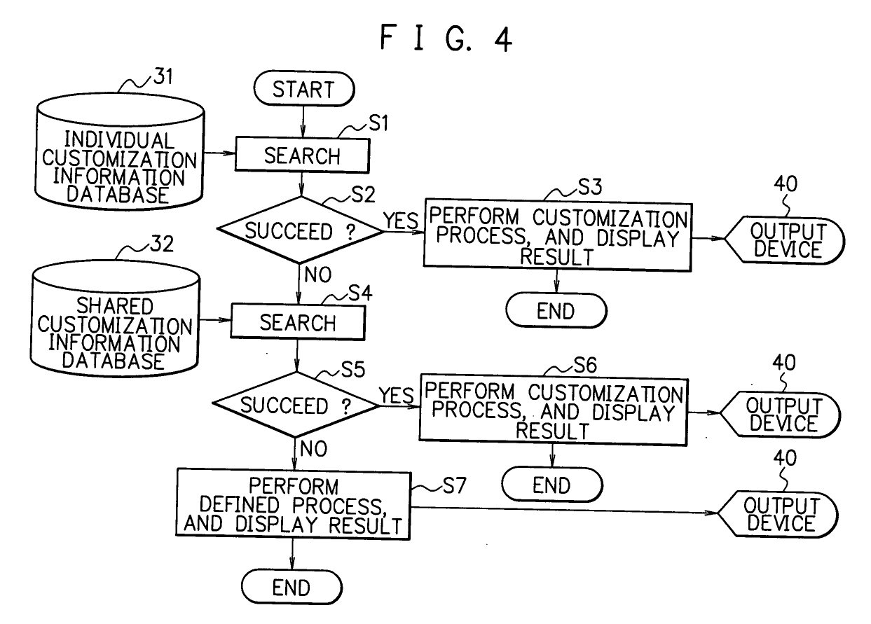

In the following, an explanation will be given of an operation when performing customization in reference to the flowchart in FIG. 4.

When a request for performing customization is input, the application package control section 21 invokes the customization performing section 23 to have the section 23 perform customization. Incidentally, the application package control section 21 may invoke the customization performing section 23 when a user inputs a request for performing customization from the input device 10 using the display screen as shown in FIG. 3. Further, the application package control section 21 may automatically invoke the customization performing section 23 when the user logs in to the application package. Incidentally, the user may arbitrarily set the timing of the invocation.

First, the customization performing section 23 searches the individual customization information database 31 of the user for customization information under the keyword(s) of a user name and an object name such as an image name and a form name (Steps S1 and S2).

When succeeding in the searching (Step S2/Yes), the customization performing section 23 performs the customization processes indicated by the retrieved customization information, and outputs the performed result to the output device 40 (Step S3).

On the other hand, when failing in the searching (Step S2/No), the customization performing section 23 searches the shared customization information database 32 for customization information under the keyword of the object name (Steps S4 and S5).

When succeeding in the searching (Step S5/Yes), the customization performing section 23 performs the customization processes indicated by the retrieved customization information, and outputs the performed result to the output device 40 (Step S6).

On the other hand, when failing in the searching (Step S5/No), the customization performing section 23 performs the processes defined in the application package as default processes, and outputs the performed result to the output device 40 (Step S7).

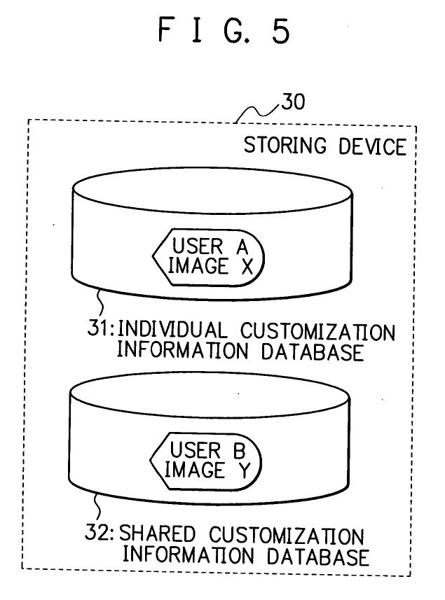

In the following, an explanation will be given of an operation of the application package device according to the present invention with a concrete example referring to FIG. 5.

In this example, it is assumed that a user A has stored customization information about an image X in the individual customization information database 31, and that a user B has stored customization information about an image Y in the shared customization information database 32 as shown in FIG. 5.

When the user A requests customization for the image X (a request for displaying the image X), the application package control section 21 invokes the customization performing section 23. The customization performing section 23 searches the individual customization information database 31 for the customization information about the image X under the keywords of the user name (A) and the image name (X).

As described above, the customization information about the image X, which was made by the user A, has been stored in the individual customization information database 31. Accordingly, the customization performing section 23 succeeds in the searching. Subsequently, the section 23 displays the image X customized by the user A on the output device 40. Namely, the application package control section 21 is customized so as to employ the image X as a display screen.

When the user A requests customization for the image Y (a request for displaying the image Y), the application package control section 21 invokes the customization performing section 23. The section 23 searches the individual customization information database 31 for the customization information for the image Y under the keywords of the user name (A) and the image name (Y). However, the section 23 fails in the searching since the customization information about the image Y is not stored in the individual customization information database 31.

Subsequently, the customization performing section 23 searches the shared customization information database 32 for the customization information about the image Y under the keyword of the image name (Y). The section 23 succeeds in the searching since the customization information about the image Y made by the user B has been stored in the database 32. The section 23 displays the image Y customized by the user B on the output section 40. Namely, the application package control section 21 is customized so as to employ the image Y as a display screen.

When the user A requests customization for an image Z (a request for displaying the image Z), the application package control section 21 invokes the customization performing section 23. The section 23 searches the individual customization information database 31 for customization information about the image Z under the keywords of the user name (A) and the image name (Z). The section 23 fails in the searching since the customization information about the image Z made by the user A is not stored in the individual customization information database 31. Subsequently, the section 23 searches the shared customization information database 32 for the customization information about the image Z under the keyword of the image name (Z). However, the section 23 fails in the searching again since the customization information about the image Z is not stored in the shared customization information database 32. Subsequently, the section 23 displays the image Z defined as a default in the application package on the display section 40.

As described above, in the application package device according to the embodiment of the present invention, the individual customization information and the shared customization information are managed separately. Further, when a user logs in to the application package for use, the application package section 20 refers only to the individual customization information database 31 associated with the user. Accordingly, the user can perform customization without causing other users inconvenience before performing an actual customization.

To be concrete, when customization is defined, customization information is stored in either the individual customization information database 31 or the shared customization information database 32. When customization is performed, the customization performing section 23 searches the individual customization information database 31 for the customization information under the keywords of a user name and an object name such as an image name and a form name. When succeeding in the searching, the section 23 performs the customization processes indicated by the retrieved customization information. When failing in the searching, the section 23 searches the shared customization information database 32 for the customization information under the keyword of the object name. When succeeding in the searching, the section 23 performs customization processes indicated by the retrieved customization information. When failing in the searching, the section 23 performs processes defined as a default in the application package.

Incidentally, the above-described embodiment may be variously modified without departing from the scope of the present invention. In the following, some modifications of the embodiment are explained.

In the above-description, the customization is performed when the user inputs a request for performing customization from the input device 10. This timing is not limited thereto, and can be changed according to user settings. For example, the application package control section 21 may invoke the customization performing section 23 when the user logs in. Subsequently, the section 23 may perform customization on the basis of the customization information stored in either the individual customization information database 31 or the shared customization information database 32.

Moreover, when the customization performing section 23 is activated at the time of logging-in, customization on the basis of customization information stored in the shared customization information database 32 may be performed.

Furthermore, the above-described embodiment is not limited to a case where the application package is installed into a single device (stand alone). The application package may be installed in a system which is comprised of plural network terminals and which the unspecified number of users may operate through their respective terminals.

When the method for customizing the application package according to the present invention is realized in an application package system, the application package device employed in the above-described embodiment may be included in the system. Moreover, the respective functions in the application package device according to the above-described embodiment may be separated and provided to terminals, etc. included in the system.

As set forth hereinbefore, in the application package device according to the present invention, the application package means customizes the application package on the basis of the customization information stored in either the individual customization information storing means or the shared customization information storing means. The application package means refers to the individual customization information storing means only when an associated user logs in.

By this means, it becomes possible for a user to store customization information in an individual customization information storing means so as to test the customization without causing other users inconvenience while operating the existing application package before performing actual customization to be applied to the other users.

Moreover, when performing the method and the program for customizing the application package, it becomes possible to obtain the same effects as those obtained by the above-described application package device.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. An application package device provided with an application package, comprising:
an application package section for executing processes based on the application package;
an individual customization information storing section provided with respect to each user for storing customization information to customize the application package; and
a shared customization information storing section for storing customization information to customize the application package, wherein:
the application package section customizes the application package on the basis of the customization information stored in either the individual customization information storing section or the shared customization information storing section, and refers to the individual customization information storing section only when an associated user logs in.

2. An application package device as claimed in claim 1, wherein:
the application package section:
searches the individual customization information storing section for customization information under the keywords of a name of a user who logs in and an object name when receiving a request for performing customization;
customizes the application package on the basis of the retrieved customization information when succeeding in searching the individual customization information storing section;
searches the shared customization information storing section for customization information under the keyword of the object name when failing in searching the individual customization information storing section;
customizes the application package on the basis of the retrieved customization information when succeeding in searching the shared customization information storing section; and
executes processes defined in the application package as a default when failing in searching the shared customization information storing section.

3. An application package device as claimed in claim 1, wherein:
the application package section comprises:
an application package control section for executing application processes defined in the application package;
a customization defining section for defining customization information in the application package; and
a customization performing section for performing customization in the application package on the basis of prestored customization information, wherein:
the application package control section invokes the customization defining section when receiving a request for defining customization, and invokes the customization performing section when receiving a request for performing customization.

4. An application package device as claimed in claim 2, wherein:
the application package section comprises:
an application package control section for executing application processes defined in the application package;
a customization defining section for defining customization information in the application package; and
a customization performing section for performing customization in the application package on the basis of prestored customization information, wherein:
the application package control section invokes the customization defining section when receiving a request for defining customization, and invokes the customization performing section when receiving a request for performing customization.

5. An application package device as claimed in claim 1, wherein:
the individual customization information storing section stores at least one customization information per one customization item that can be customized in the application package; and
the shared customization information storing section stores at most one customization information per one customization item.

6. An application package device as claimed in claim 2, wherein:
the individual customization information storing section stores at least one customization information per one customization item that can be customized in the application package; and
the shared customization information storing section stores at most one customization information per one customization item.

7. An application package device as claimed in claim 3, wherein:
the individual customization information storing section stores at least one customization information per one customization item that can be customized in the application package; and
the shared customization information storing section stores at most one customization information per one customization item.

8. An application package device as claimed in claim 4, wherein:
the individual customization information storing section stores at least one customization information per one customization item that can be customized in the application package; and
the shared customization information storing section stores at most one customization information per one customization item.

9. An application package device as claimed in claim 1, wherein:
the application package section identifies the user name of the user who logs in to the application package section by information on a log of the application package.

10. An application package device as claimed in claim 2, wherein:
the application package section identifies the user name of the user who logs in to the application package section by information on a log of the application package.

11. An application package device as claimed in claim 3, wherein:
the application package section identifies the user name of the user who logs in to the application package section by information on a log of the application package.

12. An application package device as claimed in claim 4, wherein:
the application package section identifies the user name of the user who logs in to the application package section by information on a log of the application package.

13. An application package device as claimed in claim 5, wherein:
the application package section identifies the user name of the user who logs in to the application package section by information on a log of the application package.

14. An application package device as claimed in claim 6, wherein:
the application package section identifies the user name of the user who logs in to the application package section by information on a log of the application package.

15. An application package device as claimed in claim 7, wherein:
the application package section identifies the user name of the user who logs in to the application package section by information on a log of the application package.

16. An application package device as claimed in claim 8, wherein:
the application package section identifies the user name of the user who logs in to the application package section by information on a log of the application package.

17. A method for customizing an application package in a computer provided with the application package, comprising:
an individual customization information storing step for storing customization information to customize the application package in an individual customization information storing means provided with respect to each user;
a shared customization information storing step for storing customization information to customize the application package in a shared customization information storing means; and
a customization performing step for customizing the application package on the basis of the customization information stored in either the individual customization information storing means or the shared customization information storing means, wherein:
the customization performing step is executed after executing at least one of the individual customization information storing step and the shared customization information storing step at least one time; and
the individual customization information storing means is referred to in the customization performing step only when an associated user logs in.

18. A method for customizing an application package as claimed in claim 17, wherein:
in the customization performing step, an application package means for executing processes based on the application package:
searches the individual customization information storing means for customization information under the keywords of a name of a user who logs in and an object name when receiving a request for performing customization;
customizes the application package on the basis of the retrieved customization information when succeeding in searching the individual customization information storing means;
searches the shared customization information storing means for customization information under the keyword of the object name when failing in searching the individual customization information storing means;
customizes the application package on the basis of the retrieved customization information when succeeding in searching the shared customization information storing means; and
executes processes defined as a default in the application package when failing in searching the shared customization information storing means.

19. A method for customizing an application package as claimed in claim 17, wherein:
the individual customization information storing means stores at least one customization information per one customization item that can be customized in the application package; and
the shared customization information storing means stores at most one customization information per one customization item.

20. A method for customizing an application package as claimed in claim 18, wherein:
the individual customization information storing means stores at least one customization information per one customization item that can be customized in the application package; and
the shared customization information storing means stores at most one customization information per one customization item.

21. A method for customizing an application package as claimed in claim 17, wherein:
the application package means identifies the user name of the user who logs in to the application package means by information on a log of the application package.

22. A method for customizing an application package as claimed in claim 18, wherein:
the application package means identifies the user name of the user who logs in to the application package means by information on a log of the application package.

23. A method for customizing an application package as claimed in claim 19, wherein:
the application package means identifies the user name of the user who logs in to the application package means by information on a log of the application package.

24. A method for customizing an application package as claimed in claim 20, wherein:
the application package means identifies the user name of the user who logs in to the application package means by information on a log of the application package.

25. A program for customizing an application package to have a computer provided with the application package execute:
an individual customization information storing process for storing customization information to customize the application package in an individual customization information storing means provided with respect to each user;
a shared customization information storing process for storing customization information to customize the application package in a shared customization information storing means; and
a customization performing process for customizing the application package on the basis of the customization information stored in either the individual customization information storing means or the shared customization information storing means, wherein:
the customization performing processes is executed after executing at least one of the individual customization information storing process and the shared customization information storing process at least one time; and
the individual customization information storing means is referred to in the customization performing process only when an associated user logs in.

26. A program for customizing an application package as claimed in claim 25, wherein:
in the customization performing process, the program in the application package has the computer:
search the individual customization information storing means for customization information under the keywords of a name of a user who logs in and an object name when receiving a request for performing customization;
customize the application package on the basis of the retrieved customization information when succeeding in searching the individual customization information storing means;
search the shared customization information storing means for customization information under the keyword of the object name when failing in searching the individual customization information storing means;
customize the application package on the basis of the retrieved customization information when succeeding in searching the shared customization information storing means; and
execute processes defined as a default in the application package when failing in searching the shared customization information storing means.

27. A program for customizing an application package as clamed in claim 25, wherein:
the individual customization information storing means stores at least one customization information per one customization item that can be customized in the application package; and
the shared customization information storing means stores at most one customization information per one customization item.

28. A program for customizing an application package as clamed in claim 26, wherein:
the individual customization information storing means stores at least one customization information per one customization item that can be customized in the application package; and
the shared customization information storing means stores at most one customization information per one customization item.

29. A program for customizing an application package as claimed in claim 25, wherein:
the program of the application package has the computer identify the user name of the user who logs in to the application package by information on a log of the application package.

30. A program for customizing an application package as claimed in claim 26, wherein:
the program of the application package has the computer identify the user name of the user who logs in to the application package by information on a log of the application package.

31. A program for customizing an application package as claimed in claim 27, wherein:
the program of the application package has the computer identify the user name of the user who logs in to the application package by information on a log of the application package.

32. A program for customizing an application package as claimed in claim 28, wherein:
the program of the application package has the computer identify the user name of the user who logs in to the application package by information on a log of the application package.
